(19) United States
(12) Patent Application Publication
(10) Pub. No.: US 2011/0163537 A1
(43) Pub. Date: Jul. 7, 2011

(54) PIPE CLAMP

(75) Inventors: Roger BAGGENSTOS, Jona (CH); Roman Hausheer, Cham (CH); René Huber, Jona (CH)

(73) Assignee: GEBERIT INTERNATIONAL AG, Jona (CH)

(21) Appl. No.: 12/983,617

(22) Filed: Jan. 3, 2011

(30) Foreign Application Priority Data
Jan. 5, 2010 (EP) 10 405 002.6

(51) Int. Cl. F16L 25/00

(52) U.S. Cl. 285/328

(57) ABSTRACT

The pipe clamp serves to connect a pipe (5) to a connecting piece (2) insertable into one end of the pipe (5). It has a clamping ring (9), which along its periphery possesses an annular portion (10) and a radially outwardly extending ear (11), which ear (11) is compressible by a tool. The clamping ring (9) is mounted in a clamping ring holder (15a, 15b, 15c, 15d). An ear gap cover plate (23a, 23b, 23c, 23d) bridges an annular portion (10) in the region of a gap (12). The ear gap cover plate (23a, 23b, 23c, 23d) is attached to, and in particular moulded onto the clamping ring holder (15a, 15b, 15c, 15d).

The invention relates to a pipe clamp for connecting a pipe to a connecting piece insertable into one end of the pipe, comprising a clamping ring, which along its periphery has an annular portion and a radially outwardly extending ear, which ear is compressible by a tool, comprising a clamping ring holder, in which the clamping ring is mounted, and comprising an ear gap cover plate, which bridges the annular portion in the region of a gap of the ear.

Clamping rings having an ear which is compressible with a wrench in order to tighten the clamping ring on a pipe end to be connected have long been known, for instance in the form of tube clips. When the ear is compressed, a gap of the clamping ring closes. When the clamping ring is contracted, the pipe end to be connected is not acted upon in the region of this gap. The pressing of the pipe end is therefore uneven. In order to prevent this, it is known to bridge this gap with an ear gap cover plate. In the pipe clamp according to WO 2007/101110, this ear gap cover plate is a bent section of the ear. An ear gap cover plate is likewise provided in the pipe clamp according to DE-U-20 2009 000 508. Here too, the ear gap cover plate is a bent section of the clamping ring in the region of the ear.

The object of the invention is to provide a pipe clamp of the said type, which is yet easier to produce and which nevertheless allows a round and secure pressing of a pipe end.

In a pipe clamp of the generic type, the object is achieved by the fact that the ear gap cover plate is attached to the clamping ring holder. In the pipe clamp according to the invention, the clamping ring can be produced without an ear gap cover plate and thus substantially more simply. Since the ear gap cover plate in the pipe clamp according to the invention is attached to the clamping ring holder, this cover plate can be produced substantially more simply as a plastics part, for instance by injection moulding. A bending of a sheet metal part or the like is thus unnecessary. Production is then particularly simple and cost-effective if the ear gap cover plate is moulded onto the clamping ring holder. The clamping ring holder can here be of multipart, for instance two-part construction. The ear gap cover plate is then moulded onto one of these parts. According to one refinement of the invention, the parts can be connected to one another by a latching mechanism.

According to one refinement of the invention, the ear gap cover plate has a predetermined breaking point, so that it detaches from the clamping ring holder when pressed. The ear gap cover plate then comes to bear against the outer side of the pipe end and enables a particularly round and homogeneous pressing of the pipe end. According to one refinement of the invention, the predetermined breaking point is configured as a film hinge.

According to one refinement of the invention, it is provided that the clamping ring holder has a pipe stop flange and that the ear gap cover plate is fastened to, and in particular is moulded onto this pipe stop flange. According to this refinement, the pipe stop flange thus serves for the positioning of the pipe end on the connecting piece and also for the fastening of the ear gap cover plate. However, an embodiment in which the pipe end is positioned on the connecting piece, for instance on a collar of a pipe fitting, is also conceivable. For the inspection of the pipe stop, it is provided according to one refinement of the invention that the clamping ring holder has at least one viewing window. Through a visual inspection, it is then possible to inspect the stop of the pipe end.

According to one refinement of the invention, it is provided that the clamping ring holder consists of at least two parts, which are connected to one another. As the connection, a latching connection, in particular, is provided here. According to one refinement of the invention, one of these two parts is configured in a ring shape and is provided with the ear gap cover plate, which protrudes axially from the ring. According to one refinement of the invention, one of these two parts is configured as a half-shell and, in the assembled state, bridges the ear gap cover plate with a web. For the compression of the ear, this can be undergripped with a wrench.

According to one refinement of the invention, the clamping ring holder has a calibration region. This region is preferably located at the front end of the clamping ring holder, at which the pipe end to be connected is inserted. This calibration region preferably possesses a conical surface, on which the pipe end, when inserted into the clamping ring holder, is centred and at least partially calibrated.

According to one refinement of the invention, the clamping ring holder is fastened to the connecting piece with latching means. The connecting piece is, in particular, a pipe fitting having at least one socket, which is surrounded by the pipe clamp. The connecting piece can also however be a socket of a fitting, for instance.

Further advantageous features emerge from the dependent patent claims, the following description and the drawing.

Illustrative embodiments of the invention are explained in greater detail below with reference to the drawing, in which:

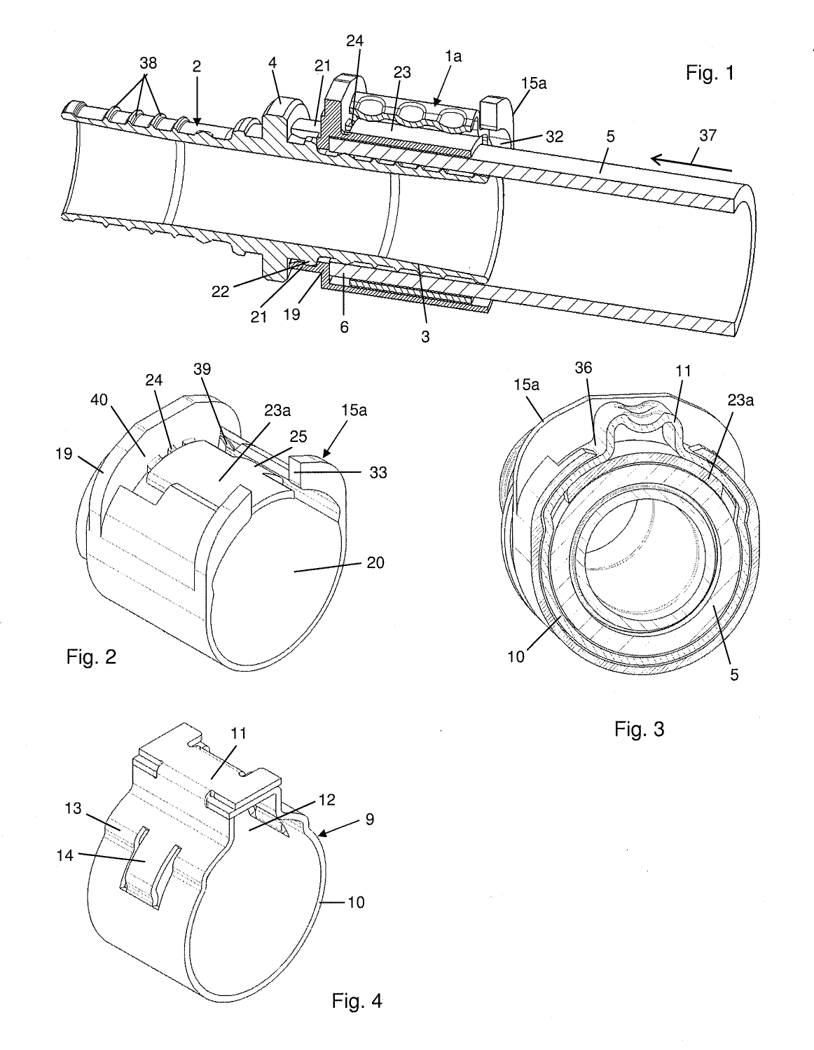

FIG. 1 shows a section through a connection to a pipe clamp according to the invention, a pipe fitting and a slipped-on pipe end,

FIG. 2 shows a three-dimensional view of a clamping ring holder,

FIG. 3 shows a three-dimensional view of a sectioned connection according to FIG. 1,

FIG. 4 shows a three-dimensional view of a clamping ring,

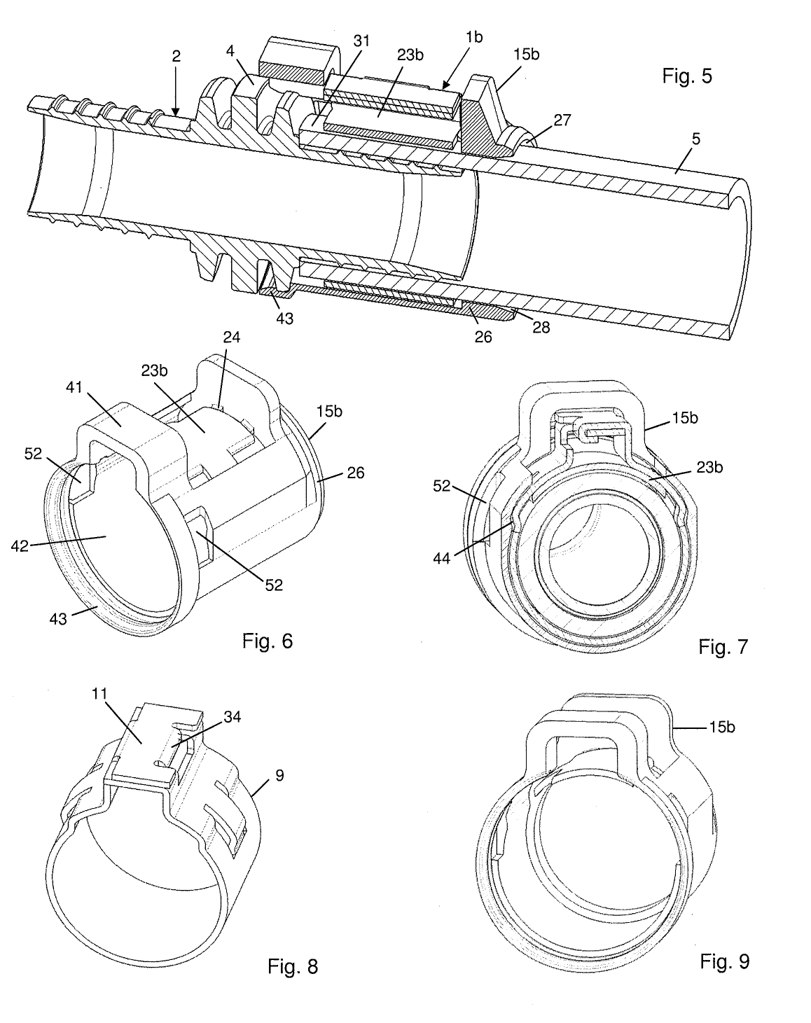

FIG. 5 shows a longitudinal section through a connection to a connecting piece, a pipe clamp according to a variant and a slipped-on pipe end,

FIG. 6 shows a three-dimensional view of the clamping ring holder according to FIG. 5,

FIG. 7 shows a three-dimensional view of a sectioned connection according to FIG. 5,

FIG. 8 shows a three-dimensional view of a clamping ring,

FIG. 9 shows a further three-dimensional view of the clamping ring holder according to FIG. 6,

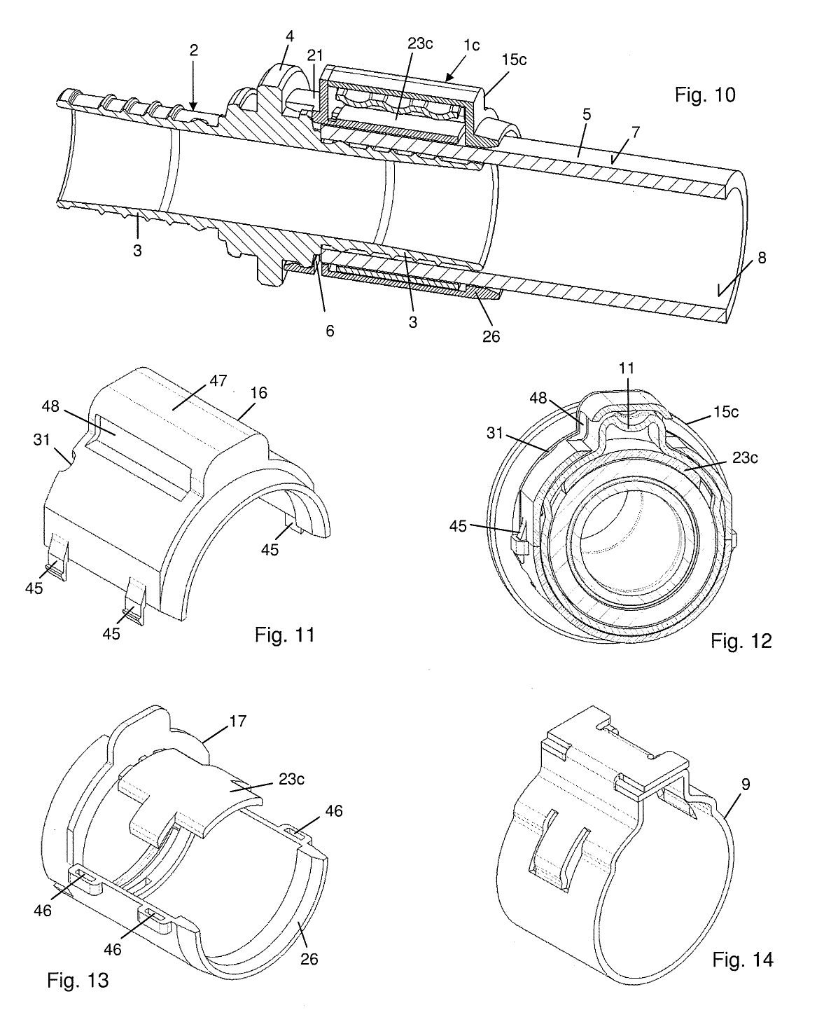

FIG. 10 shows a longitudinal section through a connection to a further variant of the clamping ring holder according to the invention,

FIG. 11 shows a three-dimensional representation of a part of the clamping ring holder according to FIG. 10,

FIG. 12 shows a three-dimensional view of the connection according to FIG. 10, which connection is sectioned,

FIG. 13 shows a three-dimensional view of a second part of the clamping ring holder according to FIG. 10, and

FIG. 14 shows a further three-dimensional view of the clamping ring,

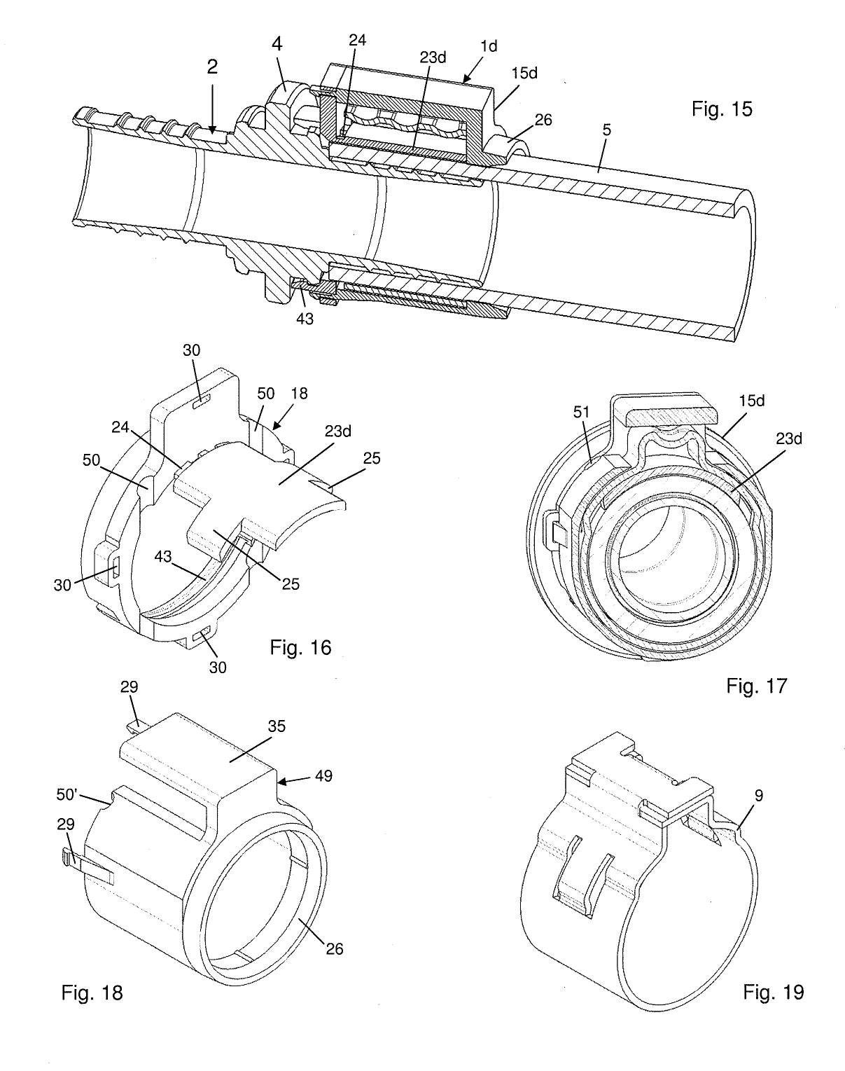

FIG. 15 shows a longitudinal section through a connection to a clamping ring holder according to a further variant,

FIG. 16 shows a three-dimensional view of a part of the clamping ring holder,

FIG. 17 shows a three-dimensional view of the connection according to FIG. 15, which connection is sectioned,

FIG. 18 shows a three-dimensional view of a second part of the clamping ring holder,

FIG. 19 shows a further three-dimensional view of the clamping ring.

FIGS. 1 to 4 show a first illustrative embodiment of a pipe clamp 1a according to the invention. According to FIG. 1, this pipe clamp 1a connects a pipe 5, for instance for a water conduit, to a connecting piece 2, which in the shown embodiment is a double pipe fitting having a collar 4. The pipe 5 is, in particular, a water pipe, for instance a bendable composite pipe. In order to connect the connecting piece 2 to the pipe 5, the latter is slipped onto a socket 3 of the connecting piece 2, according to the arrow 37, until a front side 6 of the pipe 5 butts against a pipe stop flange 19 of the pipe clamp 1a. Next the pipe clamp 1a is pressed with a wrench (not shown here). The pipe 5 is then connected in a substantially non-detachable manner to the connecting piece 2.

The pipe clamp 1a possesses a clamping ring 9, which is mounted in a clamping ring holder 15a. The clamping ring 9 is made, for instance, from a portion of a metal strip and possesses according to FIG. 4 an annular portion 10 and a so-called ear 11, which projects radially with respect to the annular portion 10. The annular portion 10 is interrupted in the region of the ear 11 by a gap 12. The annular portion 10 possesses two radially somewhat projecting tongues 14 and, respectively between this tongue 14 and the ear 11, a shoulder 13. As can be seen, the clamping ring 9 is closed, wherein according to FIG. 8 a bent section 34 connects the two ends one to the other in the region of the ear 11. The ear 11 can be configured differently. According to FIG. 3, it possesses two lateral grip recesses 36, so that the ear 11 can be gripped and compressed with a wrench (not shown here). The annular portion 10 is thereby reduced in size and lays itself around the pipe 5 and presses this, so that ribs 38 of the socket 3 embed themselves in the inside of the pipe 5. The clamping ring 9 preferably consists of a suitable metal. In the assembly process, the clamping ring 9 is inserted through an opening 32 (FIG. 1) into a cavity 20 of the clamping ring holder 15a. The ear 11 is hereupon inserted through an opening 33 (shown in FIG. 2) into a window 39 of the clamping ring holder 15a. To this end, the opening 33 can be widened. The ear 11 juts through the window 39 and thus projects radially, according to FIG. 3, on the outer side of the clamping ring holder 15a. The ear 11 can thus be gripped from outside with the jaws of a wrench.

The clamping ring holder 15a possesses an ear gap cover plate 23a, which is fastened to an inner side 40 of the pipe stop flange 19. The fastening is realized with a predetermined breaking point 24, which is configured as a film hinge. Preferably, the ear gap cover plate 23a is moulded onto the pipe stop flange 19; in principle, however, another connection, for instance a latching connection, would also be conceivable here. The ear gap cover plate 23a extends axially beneath the ear 11 and thus closes the gap 12. As FIG. 3 shows, the ear gap cover plate 23a is substantially wider than the gap 12 and thus extends beyond this in both peripheral directions. In the region to be pressed, the pipe 5 is thus surrounded, on the one hand, by the annular portion 10 and, on the other hand, by the ear gap cover plate 23a. In the pressing process, a force thus acts all the way round upon the pipe 5, so that a homogeneous and round pressing of the pipe 5 is ensured. In the pressing process, a radially inwardly directed force acts upon the ear gap cover plate 23a. The predetermined breaking point 24 thereby ruptures and the ear gap cover plate 23a can thus be pressed fully radially inwards against the pipe 5. Moulded onto the side of the ear gap cover plate 23a are two lugs 25, which respectively extend in a peripheral direction of the pipe 5 and which respectively undergrip one of the two tongues 14. The lugs 25 guide the ear gap cover plate 23a during the pressing and secure the clamping ring 9 in the axial direction. The shoulders 13 are configured such that, in the pressing of the ear 11, they can shift in the peripheral direction towards the ear gap cover plate 23a. FIG. 3 shows the clamping ring 9 in the unpressed state. In the pressed state, the shoulders 13, viewed in the peripheral direction, are then closer to the ear gap cover plate 23a or even bear against it.

The clamping ring holder 15a is preferably premounted on the connecting piece 2. In this case, the clamping ring holder 15a is latched on the connecting piece 2 by means of latching tongues 21 and a latching element 22 of the connecting piece 2. The latching element 22 is a circumferential, radially projecting rib of the socket 3. In order to connect the pipe 5 to the connecting piece 2, the pipe 5 thus has merely to be inserted through the opening 32 in the direction of the arrow 37 into the interspace between the clamping ring 9 and the socket 3 up to the pipe stop flange 19, after which the clamping ring 9 must be pressed on the ear 11 with a wrench.

FIGS. 5 to 9 show a pipe clamp 1b according to one variant. The above-stated basic design features also apply in this embodiment. In particular, the clamping ring 9 which has already been described above is provided here too. Here, however, the clamping ring holder 15b is configured such that the clamping ring 9 is inserted into the clamping ring holder 15b from the rear. The pipe 5 is inserted up to a stop on the collar 4 of the connecting piece 2. Thus, the abovementioned pipe stop flange 19 is not provided here. Two viewing windows 52 on the clamping ring holder 15b enable an inspection of the stop of the pipe 5 on the collar 4. According to FIG. 6, the clamping ring holder 15a possesses on the rear side a cavity 42, which is configured such that it substantially corresponds to the outer profile of the clamping ring 9. Corresponding to the ear 11 in this case is a bulge 41, through which the ear 11 can be pushed. The clamping ring 9 can thus be inserted into the cavity 42 of the clamping ring holder 15a from the rear. Here too, an ear gap cover plate 23b bridges the gap 12 of the clamping ring 9, as is explained above. The ear gap cover plate 23b is here, however, moulded onto an annular calibration region 26. This calibration region 26 possesses on the inner side a conical surface 28, on which the pipe 5 is calibrated as it is inserted into the pipe clamp 1b. The function and the advantages of the ear gap cover plate 23b correspond to those of the ear gap cover plate 23a described above.

At the rear end, the clamping ring holder 15b possesses a latching rib 43, with which it can be latched detachably on the collar 4 of the connecting piece 2. In the axial direction, the clamping ring 9 is held by the calibration region 26 and by the collar 4. In order to prevent possible twisting of the clamping ring 9 in the clamping ring holder 15b in the peripheral direction, the clamping ring holder 15b possesses according to FIG. 7 an inner contour 44, which in some regions corresponds to the outer contour of the clamping ring 9. Thus the ear 11 is here respectively positioned in the clamping ring holder 15b such that it can be gripped with the wrench for pressing purposes.

FIGS. 10 to 14 show a pipe clamp 1c according to a further variant according to the invention. This pipe clamp 1c differs from the abovementioned variants essentially in terms of the design of the clamping ring holder 15c. This consists of the holding parts 16 and shown in FIGS. 11 and 13. As can be seen, the holding part 16 is configured in the shape of a half-shell and possesses latching tongues 45. Moulded onto a top side is a web 47, which has two lateral mutually opposing windows 48 provided for the passage of the wrench jaws. The web 47 covers an ear gap cover plate 23c, which is otherwise configured as described above. This ear gap cover plate 23c is moulded onto the holding part 17 shown in FIG. 3. The holding part 17 possesses latching openings 46, in which, in the assembled state, the latching tongues 45 engage. FIGS. 10 and 12 show the clamping ring holder 15c in the assembled state. A calibration region 26 is likewise provided. In the assembly process, the clamping ring 9 is first inserted into the holding part 17. Next the holding part 16 is placed onto the holding part 17 and latched onto it. The clamping ring 9 is then held radially and axially in the clamping ring holder 15c. The pipe 11 can be gripped through the window 48 with a wrench and pressed. Otherwise the abovementioned features and advantages apply. Viewing windows 31 enable the stop of the pipe 5 on the collar 4 to be inspected.

The pipe clamp 1d shown in FIGS. 15 to 19 possesses a clamping ring holder 15d, which is composed of two holding parts 18 and 49. A latching rib 43, with which the clamping ring holder 15d is fastened to the connecting piece 2, is formed by the holding part 18, which, as can be seen, is configured in a ring shape and onto which there is moulded an ear gap cover plate 23d having a predetermined breaking point 24. The holding part 49 is configured in the shape of a sleeve and forms the calibration region and a web 35 substantially corresponding to the web 47. The holding parts 18 and 49 can be latched together and, to this end, possess latching tongues 29 and corresponding latching openings 30. In the assembly process, the clamping ring 9 is placed onto the holding part 18, after which the holding part 49 is mounted and latched in place. Two mutually opposing viewing windows 51, through which a visual inspection of the stop of the pipe 5 on the collar 4 is possible, are formed by cavities 50 and 50′ on the holder 18 and 49 respectively (FIG. 17).

REFERENCE SYMBOL LIST

| 1a, 1b, 1c, 1d | pipe clamp |
|---|---|
| 2 | connecting piece |
| 3 | socket |
| 4 | collar |
| 5 | pipe |
| 6 | front side |
| 7 | outer side |
| 8 | inner side |
| 9 | clamping ring |
| 10 | annular portion |
| 11 | ear |
| 12 | gap |
| 13 | shoulder |
| 14 | tongue |
| 15a, 15b, 15c, 15d | clamping ring holder |
| 16 | holding part |
| 17 | holding part |
| 18 | holding part |
| 19 | pipe stop flange |
| 20 | cavity |
| 21 | latching tongue |
| 22 | latching element |
| 23a, 23b, 23c, 23d | ear gap cover plate |
| 24 | predetermined breaking point |
| 25 | lug |
| 26 | calibration region |
| 27 | opening |
| 28 | surface |
| 29 | latching tongue |
| 30 | latching opening |
| 31 | viewing window |
| 32 | opening |
| 33 | opening |
| 34 | bent section |
| 35 | web |
| 36 | grip recess |
| 37 | arrow |
| 38 | ribs |
| 39 | window |
| 40 | inner side |

1.-15. (canceled)

16. A Pipe clamp for connecting a pipe to a connecting piece insertable into one end of the pipe, comprising a clamping ring, which along its periphery has an annular portion and a radially outwardly extending ear, which ear is compressible by a tool, comprising a clamping ring holder, in which the clamping ring is mounted, and comprising an ear gap cover plate, which bridges the annular portion in the region of a gap of the ear, wherein the ear gap cover plate is attached to the clamping ring holder.

17. The pipe clamp according to claim 16, wherein the ear gap cover plate is moulded onto the clamping ring holder.

18. The pipe clamp according to claim 16, wherein the ear gap cover plate has a predetermined breaking point, so that it detaches from the clamping ring holder when the clamping ring is pressed.

19. The pipe clamp according to claim 18, wherein the predetermined breaking point is configured as a film hinge.

20. The pipe clamp according to claim 19, wherein the ear gap cover plate extends axially from the predetermined breaking point.

21. The pipe clamp according to claim 16, wherein the clamping ring holder has a pipe stop flange.

22. The pipe clamp according to claim 16, wherein the clamping ring holder consists of a first and a second part, which are connected one to the other.

23. The pipe clamp according to claim 22, wherein the at least two parts are latched together.

24. The pipe clamp according to claim 16, wherein the clamping ring is inserted into the clamping ring holder axially from the front or rear.

25. The pipe clamp according to claim 16, wherein the clamping ring holder has at a front end a calibration region for calibrating the pipe to be connected.

26. The pipe clamp according to claim 16, wherein the clamping ring is held in the clamping ring holder in a twist-proof manner.

27. The pipe clamp according to claim 16, wherein the clamping ring holder has at least one viewing window for an inspection of the pipe stop.

28. The pipe clamp according to claim 16, wherein the clamping ring holder has latching means for its fastening to the connecting piece.

29. The pipe clamp according to claim 16, wherein the ear gap cover plate extends beyond the gap in the peripheral direction at least on one side.

30. The pipe clamp according to claim 16, wherein the clamping ring is held axially in the clamping ring holder by way of lugs.
